(19) United States
(12) Patent Application Publication
(10) Pub. No.: US 2016/0181849 A1
(43) Pub. Date: Jun. 23, 2016

(54) SYSTEM AND METHOD FOR THERMAL MANAGEMENT IN WIRELESS CHARGING DEVICES

(71) Applicant: QUALCOMM Incorporated, San Diego, CA (US)

(72) Inventor: Arvind Govindaraj, San Diego, CA (US)

(21) Appl. No.: 14/578,819

(22) Filed: Dec. 22, 2014

(51) Int. Cl. H02J 7/02; H02J 7/00

(52) U.S. Cl. CPC H02J 7/025; H02J 7/007

(57) ABSTRACT

The invention described herein relates to wireless power transfer systems and methods that efficiently and safely transfer power to electronic devices. In an aspect of the disclosure, an apparatus for wirelessly transmitting power is provided. The apparatus may comprise a wireless power transmitter and a charging surface. The charging surface at least partially covers the wireless power transmitter and is formed with an array of orthogonally disposed protrusions. The protrusions are configured to extend away from the charging surface.

### TECHNICAL FIELD

This application is generally related to wireless power charging of chargeable devices such as mobile electronic devices.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that physically connect the rechargeable devices to a power supply. Cables and similar connectors may sometimes be inconvenient or cumbersome and have other drawbacks. Wireless charging systems that are capable of transferring power in free space to charge rechargeable electronic devices or provide power to electronic devices may overcome some of the deficiencies of wired charging solutions. As such, wireless power transfer systems and methods that efficiently and safely transfer power to electronic devices are desirable.

Fast battery charging is a desirable feature in consumer electronics devices such as tablets and mobile phones. Fast charging batteries are said to be capable of charging at “high C rates,” meaning they can absorb energy at high power levels. However, fast charging may be limited by the temperature of the battery rather than the ability of the wired/wireless charger or power transmit unit (PTU) to provide requisite power. This situation is exacerbated in wireless power charging systems as the charging device or power receiver unit (PRU) may be placed directly on or in close proximity to the PTU surface where the PTU surface temperature is higher than ambient temperatures (as described below).

The surface of the PTU may run at a higher than ambient temperature due to thermal power dissipation. Additionally, wireless charging creates further thermal power dissipation within the PRU. Some systems attempt to combat the increased temperature via passive cooling, or isolation systems, and thus have limited heat dissipation capability. Increased temperature may lead to reduced fast-charge capability resulting in increased charging times.

### SUMMARY

The systems, methods, and devices of the invention each have several aspects, no single one of which is solely responsible for its desirable attributes. The implementations disclosed herein each have several innovative aspects, no single one of which is solely responsible for the desirable attributes of the invention. Without limiting the scope of this invention as expressed by the claims which follow, some features will now be discussed briefly. After considering this discussion, and particularly after reading the section entitled “Detailed Description,” one will understand how the features of the various implementations of this invention provide advantages that include improved wireless charging between wireless power transmitting units and wireless power receiving units.

In an aspect of the disclosure, an apparatus for wirelessly transmitting power is provided. The apparatus may comprise a wireless power transmitter and a charging surface. The charging surface at least partially covers the wireless power transmitter and is formed with an array of orthogonally disposed protrusions. The protrusions are configured to extend away from the charging surface.

Another aspect of the disclosure relates to another apparatus for wirelessly transmitting power. The apparatus may comprise a charging surface and a controller. The charging surface may be configured for placement of one or more devices to be wirelessly charged via a wireless power transmitting unit and may comprise one or more thermoelectric conductors, at least one heat sink, and one or more sensors. The at least one heat sink is operably connected to the one or more thermoelectric conductors and is disposed on a peripheral edge of the charging surface. The one or more sensors are configured to sense a surface temperature of the charging surface. The controller is operably connected to the one or more thermoelectric conductors and the one or more sensors. The controller is configured to receive an indication of the surface temperature of the charging surface and selectively enable the one or more thermoelectric conductors based on the surface temperature.

Another aspect of the disclosure relates to an apparatus for wirelessly receiving power. The apparatus comprises at least one sensor, a memory, a predictive thermal controller, and a transceiver. The at least one sensor is configured to provide an indication of a surface temperature of the power receiving unit at a position in contact with or in the vicinity of a power transmitting unit from which the power receiving unit wirelessly receives power. The memory is configured to store a tuned thermal model of the power receiving unit. The predictive thermal controller operably couples to the at least one sensor and the memory and is configured to predict a temperature rise at the power receiving unit based at least in part on the indication provided by the at least one sensor and a power demand of the power receiving unit. The predictive thermal controller is further configured to generate a transmission to the power transmitting unit based on the surface temperature and a target temperature from the tuned thermal model. The transceiver is configured to transmit the transmission to the power transmitting unit.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Throughout the drawings, similar symbols typically identify similar components, unless context dictates otherwise. Note that the relative dimensions of the following figures may not be drawn to scale.

FIG. 1 is a functional block diagram of a wireless power transfer system, in accordance with one example of an implementation.

FIG. 2A is a functional block diagram of a wireless power transfer system, in accordance with another example implementation.

FIG. 2B is a functional block diagram of a wireless power transfer system, in accordance with another example implementation.

FIG. 3 is a schematic diagram of a portion of transmit circuitry or receive circuitry of FIG. 2A including a transmit or receive antenna, in accordance with some example implementations.

FIG. 4A is a side view of a thermal management system for wireless power transfer systems in accordance with an embodiment.

FIG. 4B depicts a top view of the thermal management system of FIG. 4A.

FIG. 4C depicts a side view of a thermal management system, in accordance with another embodiment.

FIG. 5 depicts a top view of a power transmitting unit in accordance with another exemplary embodiment.

FIG. 6 depicts a block diagram of a thermal management system according to another exemplary embodiment.

FIG. 7 is a flowchart depicting a method for managing thermal power dissipation according to the disclosure.

### DETAILED DESCRIPTION

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “receive antenna” to achieve power transfer.

The terminology used herein is for the purpose of describing particular embodiments only and is not intended to be limiting of the disclosure. It will be understood by those within the art that if a specific number of a claim element is intended, such intent will be explicitly recited in the claim, and in the absence of such recitation, no such intent is present. For example, as used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Electrical and electronic processes often generate waste heat. Waste heat is energy that is necessarily produced by processes requiring energy, such as electrical and electronic processes, including wired and wireless power transfer and charging operations. As generally referred to herein, waste heat may also include thermal power dissipation of one or more of the devices involved in wireless power transfer. “Waste heat” may alternatively be referred to herein as “heat power dissipation” or “thermal power dissipation.” The terms may generally be used interchangeably.

Although relatively small in magnitude, waste heat in electronics may adversely affect the performance of an electronic device, e.g., a mobile device such as those described below. Increased temperatures may result in decreased efficiency of charging operations and shortened operating life of a power storage device, for example, a battery being charged, or the electronic device, for example, a mobile wireless device. Thus, efficient dissipation or disposal of waste heat in electronics may increase efficiency and operating life of the components.

In a wireless power transfer system similar to those described herein, a PTU transfers wireless power to a PRU. In operation, the PTU and the PRU may be in close proximity or in contact with one another in order to optimize the transfer of wireless power. In general, one or both of the PTU and PRU may increase in temperature during the charging operations. As inductive power is transferred some of the energy is lost as waste heat. Accordingly, one or both of the PTU and the PRU may increase in temperature during power transfer.

The surface of the PTU may run at a higher than ambient temperature due to thermal power dissipation. Additionally, wireless charging creates further thermal power dissipation within the PRU as the PRU systems are powered or during charging operations. Some systems attempt to combat the increased temperature via passive cooling, or thermal isolation systems, however these systems have limited heat dissipation capability. Increased temperature of the PTU and PRU may lead to a reduction in charge capability. This may further result in increased charging times.

In order to increase wireless power transfer from the PTU to the PRU, a number of thermal management solutions may be implemented. By decreasing the PTU surface temperature, the PRU temperature may be managed. For example, improving thermal conductivity from the battery (or back cover or housing, etc.) to the environment may lower the PRU operating temperatures and may increase the charging rate (“C-rate”) of the PRU.

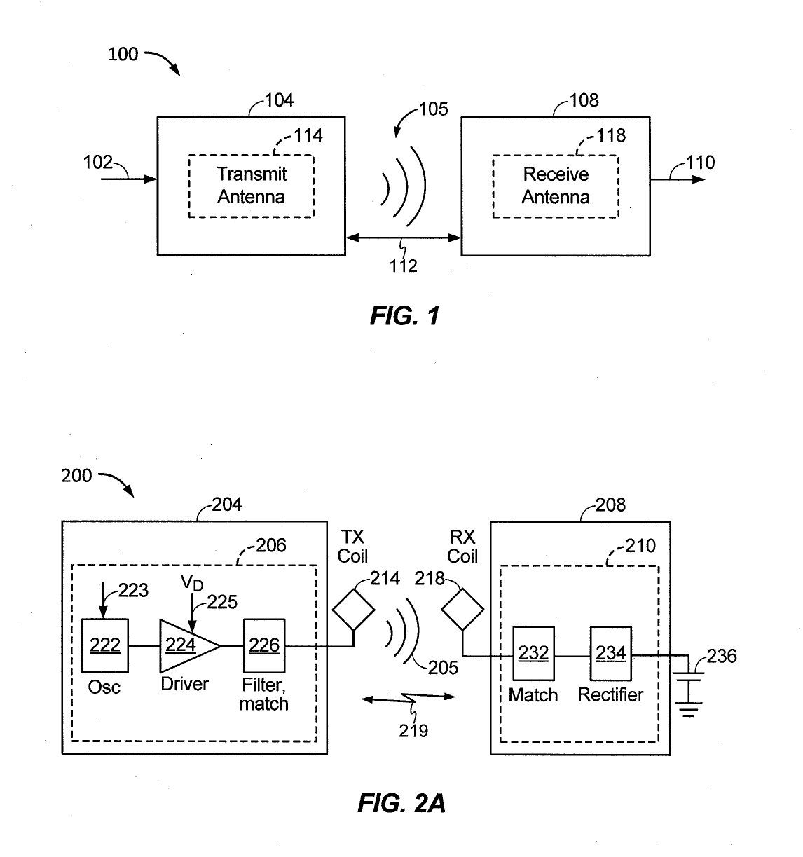

FIG. 1 is a functional block diagram of a wireless power transfer system 100, in accordance with one example implementation. An input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate an output power 110 for storing or consumption by a device (not shown in this figure) coupled to the output power 110. Both the transmitter 104 and the receiver 108 are separated by a distance 112.

In one example implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are minimal. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The transmitter 104 may include a transmit antenna or coil 114 for transmitting energy to the receiver 108. The receiver 108 may include a receive antenna or coil 118 for receiving or capturing energy transmitted from the transmitter 104. The near-field may correspond to a region in which there are strong reactive fields resulting from the currents and charges in the transmit coil 114 that minimally radiate power away from the transmit antenna or coil 114. The near-field may correspond to a region that is within about one wavelength (or a fraction thereof) of the transmit coil 114.

As described above, efficient energy transfer may occur by coupling a large portion of the energy in the wireless field 105 to the receive coil 118 rather than propagating most of the energy in an electromagnetic wave to the far field. When positioned within the wireless field 105, a “coupling mode” may be developed between the transmit coil 114 and the receive coil 118. The area around the transmit antenna 114 and the receive antenna 118 where this coupling may occur is referred to herein as a coupling-mode region.

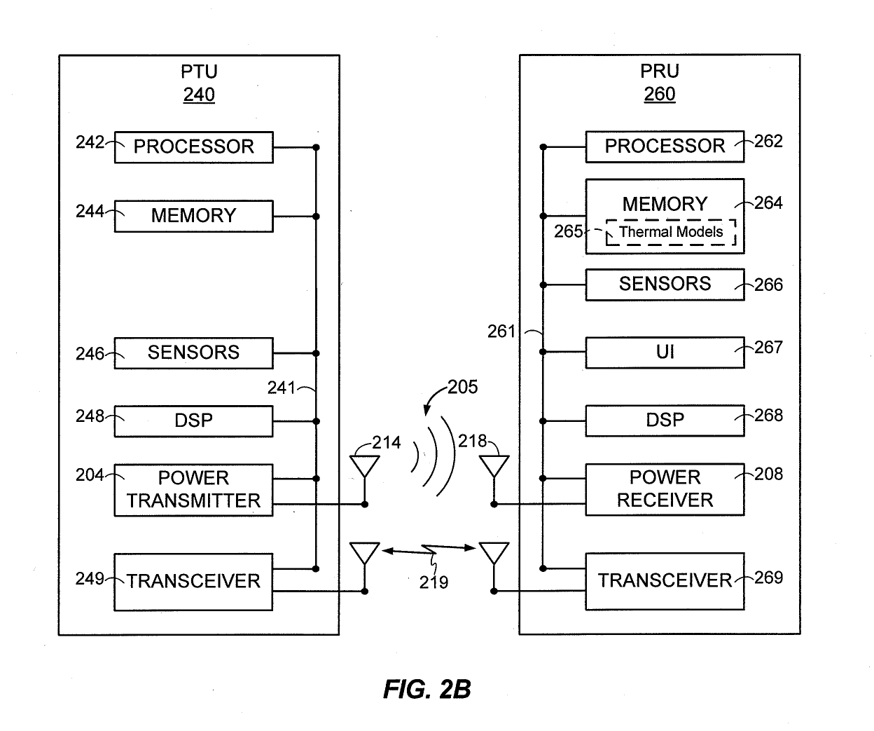

FIG. 2A is a functional block diagram of a wireless power transfer system 200, in accordance with another example implementation. The system 200 may be a wireless power transfer system of similar operation and functionality as the system 100 of FIG. 1. However, the system 200 provides additional details regarding the components of the wireless power transfer system 200 than FIG. 1. The system 200 includes a power transmitter 204 and a power receiver 208. The power transmitter 204 may include a transmit circuitry 206 that may include an oscillator 222, a driver circuit 224, and a filter and matching circuit 226. The oscillator 222 may be configured to generate a signal at a desired frequency that may be adjusted in response to a frequency control signal 223. The oscillator 222 may provide the oscillator signal to the driver circuit 224. The driver circuit 224 may be configured to drive the transmit antenna 214 at, for example, a resonant frequency of the transmit antenna 214 based on an input voltage signal (VD) 225. The driver circuit 224 may be a switching amplifier configured to receive a square wave from the oscillator 222 and output a sine wave.

The filter and matching circuit 226 may filter out harmonics or other unwanted frequencies and match the impedance of the power transmitter 204 to the transmit antenna 214. As a result of driving the transmit antenna 214, the transmit antenna 214 may generate a wireless field 205 to wirelessly output power at a level sufficient for charging a battery 236 of a wireless mobile device, for example.

The power receiver 208 may include a receive circuitry 210 that may include a matching circuit 232 and a rectifier circuit 234. The matching circuit 232 may match the impedance of the receive circuitry 210 to the receive antenna 218. The rectifier circuit 234 may generate a direct current (DC) power output from an alternate current (AC) power input to charge the battery 236 via additional circuitry (not shown in this figure), as shown in FIG. 2A. The power receiver 208 and the power transmitter 204 may additionally communicate on a separate communication channel 219 (e.g., Bluetooth, ZigBee, cellular, etc.). The power receiver 208 and the power transmitter 204 may alternatively communicate via in-band signaling using characteristics of the wireless field 205.

The power receiver 208 may be configured to determine whether an amount of power transmitted by the power transmitter 204 and received by the power receiver 208 is appropriate for charging the battery 236.

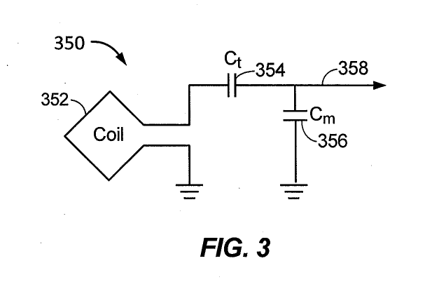

FIG. 2B shows an exemplary functional block diagram of a PTU transferring wireless power to a PRU. As shown, a PTU 240 may utilize the processes and methods disclosed herein. The PTU 240 is an example of a device that may be configured to transmit wireless power in accordance with the descriptions of FIG. 1, FIG. 2A, and FIG. 3 (below).

The PTU 240 may comprise a processor 242 configured to control the operation of the PTU 240. The processor 242 may also be referred to as a central processing unit (CPU). The processor 242 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The PTU 240 may further comprise a memory 244, which may include both read-only memory (ROM) and random access memory (RAM), may provide instructions and data to the processor 242. The memory 244 may be operably coupled to the processor 242. A portion of the memory 244 may also include non-volatile random access memory (NVRAM). The processor 242 typically performs logical and arithmetic operations based on program instructions stored within the memory 244. The instructions in the memory 244 may be executable to implement the methods described herein.

The PTU 240 may further comprise one or more sensors 246 operably coupled to the processor 242 and/or the memory 244 via a bus 241. The bus 241 may include a data bus, for example, as well as a power bus, a control signal bus, and a status signal bus. Those of skill in the art will appreciate that the components of the PTU 240 may be coupled together or accept or provide inputs to each other using some other mechanism.

The sensors 246 may include, but are not limited to temperature sensors, thermistors, or other types of thermometers. The sensors 246 may be configured to sense the temperature of the surface of the PTU 240 in contact with the adjacent surface of a PRU 260 or sense the temperature of one or more components or locations of the PTU 240.

The PTU 240 may also include a digital signal processor (DSP) 248 for use in processing signals. The DSP 248 may be configured to generate a packet for transmission.

The PTU 240 may also comprise the power transmitter 204 and the transmit antenna 214 of FIG. 2A for transmission of wireless power via the wireless field 205, for reception by the PRU 260 at the receive antenna 218 (FIG. 2B).

The PTU 240 may also comprise a transceiver 249 allowing transmission and reception of data between the PTU 240 and the PRU 260 via the communication channel 219. Such data and communications may be received by a transceiver 269 within the PRU 260. The PTU 240 may use the transceiver 249 to transmit information from the sensors 246 to the PRU 260 which may be utilized by the PRU 260. The PRU 260 may further transmit commands and independent sensor information to the PTU 240 for configuring the transmit power level of the wireless field 205 allowing thermal management and controlling thermal power dissipation. In some embodiments, the transceiver 249 and the power transmitter 204 may share the transmit antenna 214. For example, in an aspect of an embodiment, the transceiver 249 may be configured to send data via modulation of the wireless field 205 used for transferring power. In another example the communication channel 219 is different than the wireless field 205, as shown in FIG. 2B. In another example, the transceiver 249 and the power transmitter 204 may not share the transmit antenna 214 and may each have their own antennas.

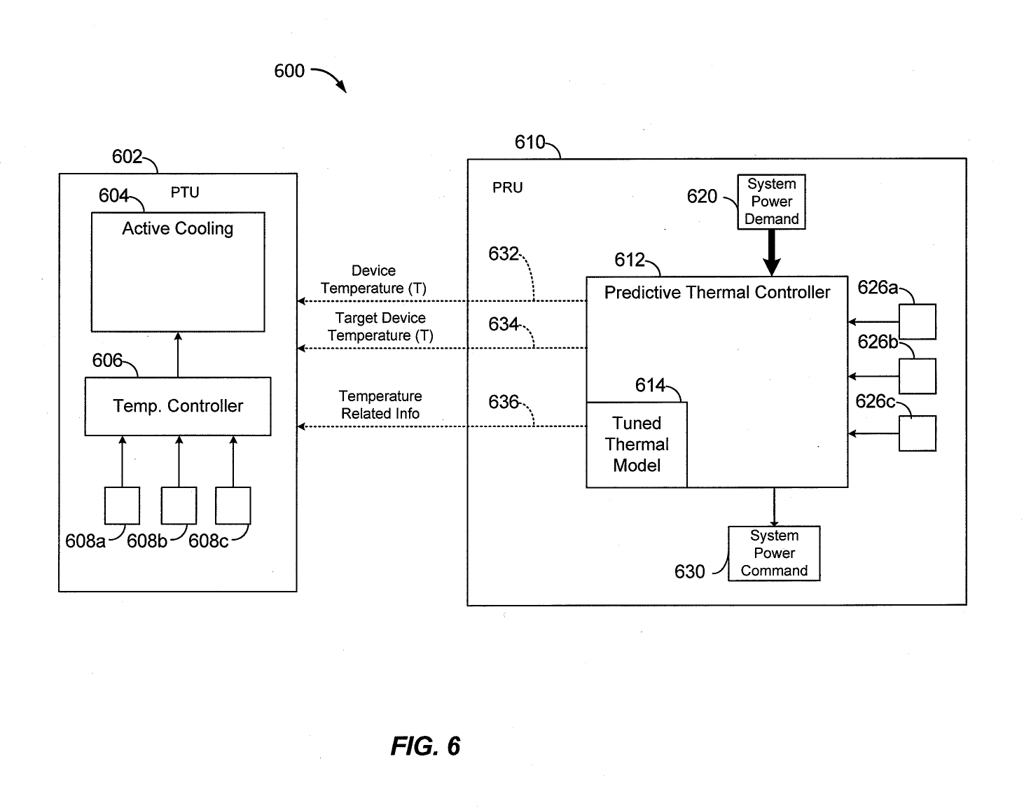

The PRU 260 may comprise a processor 262, one or more sensors 266, a DSP 268 and a transceiver 269 similar to the corresponding components of the PTU 240. The PRU 260 may further comprise a memory 264 similar to the memory 244, described above. The memory 264 may further store tuned thermal models 265 describing certain thermal characteristics of both the PTU 240 and of the PRU 260. The tuned thermal models 265 are further described below in connection with FIG. 6. Similar to the memory 244, the memory 264 may comprise both read-only memory (ROM) and random access memory (RAM), may provide instructions and data to the processor 262. A portion of the memory 264 may also include non-volatile random access memory (NVRAM).

The PRU 260 may further comprise a user interface (UI) 267 in some aspects. The user interface 267 may comprise a keypad, a microphone, a speaker, and/or a display. The user interface 267 may include any element or component that conveys information to a user of the PRU 260 and/or receives input from the user.

The PRU 260 may also comprise the power receiver 208 of FIG. 2A for receiving wireless power via the wireless field 205 from the power transmitter 204 using the receive antenna 218. The power receiver 208 may be operably connected to the processor 262, the memory 264, the sensor 266, UI 267 and DSP 268 via a bus 261, similar to the bus 241. Those of skill in the art will appreciate that the components of the PRU 260 may be coupled together or accept or provide inputs to each other using some other mechanism.

Although a number of separate components are illustrated in FIG. 2B, those of skill in the art will recognize that one or more of the components may be combined or commonly implemented. For example, the processor 242 may be used to implement not only the functionality described above with respect to the processor 242, but also to implement the functionality described above with respect to the sensors 246 and/or the DSP 248. Likewise, the processor 262 may be used to implement not only the functionality described above with respect to the processor 262, but also to implement the functionality described above with respect to the sensor 266 and/or the DSP 268. Further, each of the components illustrated in FIG. 2B may be implemented using a plurality of separate elements.

FIG. 3 is a schematic diagram of a portion of the transmit circuitry 206 or the receive circuitry 210 of FIG. 2A, in accordance with some example implementations. As illustrated in FIG. 3, a transmit or receive circuitry 350 may include an antenna or coil 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, the antenna 352 is an example of a “power transfer component” of a type that is configured to wirelessly output and/or receive power.

The antenna 352 may include an air core or a physical core such as a ferrite core (not shown in this figure). Air core loop antennas may be more tolerable to extraneous physical devices placed in the vicinity of the core. Furthermore, an air core loop antenna 352 allows the placement of other components within the core area. In addition, an air core loop may more readily enable placement of the receive antenna 218 within a plane of the transmit antenna 214 where the coupled-mode region of the transmit antenna 214 may be more powerful.

As stated, efficient transfer of energy between the transmitter 104 (power transmitter 204 as referenced in FIG. 2A and FIG. 2B) and the receiver 108 (power receiver 208 as referenced in FIG. 2A and FIG. 2B) may occur during matched or nearly matched resonance between the transmitter 104 and the receiver 108. However, even when resonance between the transmitter 104 and receiver 108 are not matched, energy may be transferred, although the efficiency may be affected. For example, the efficiency may be less when resonance is not matched. Transfer of energy occurs by coupling energy from the wireless field 105 (wireless field 205 as referenced in FIG. 2A and FIG. 2B) of the transmit coil 114 (transmit antenna 214 as referenced in FIG. 2A and FIG. 2B) to the receive coil 118 (receive antenna 218 as referenced in FIG. 2A and FIG. 2B), residing in the vicinity of the wireless field 105, rather than propagating the energy from the transmit coil 114 into free space.

The resonant frequency of the loop or magnetic antennas is based on the inductance and capacitance. Inductance may be simply the inductance created by the antenna 352, whereas, capacitance may be added to the antenna's inductance to create a resonant structure at a desired resonant frequency. As a non-limiting example, a capacitor 354 and a capacitor 356 may be added to the transmit or receive circuitry 350 to create a resonant circuit that selects a signal 358 at a resonant frequency. Accordingly, for larger diameter antennas, the size of capacitance needed to sustain resonance may decrease as the diameter or inductance of the loop increases.

Furthermore, as the diameter of the antenna 352 increases, the efficient energy transfer area of the near-field may increase. Other resonant circuits formed using other components are also possible. As another non-limiting example, a capacitor may be placed in parallel between the two terminals of the circuitry 350. For transmit antennas, the signal 358, with a frequency that substantially corresponds to the resonant frequency of the antenna 352, may be an input to the antenna 352.

In FIG. 1, the transmitter 104 may output a time varying magnetic (or electromagnetic) field with a frequency corresponding to the resonant frequency of the transmit coil 114. When the receiver 108 is within the wireless field 105, the time varying magnetic (or electromagnetic) field may induce a current in the receive coil 118. As described above, if the receive coil 118 is configured to resonate at the frequency of the transmit coil 114, energy may be efficiently transferred. The AC signal induced in the receive coil 118 may be rectified as described above to produce a DC signal that may be provided to charge or to power a load.

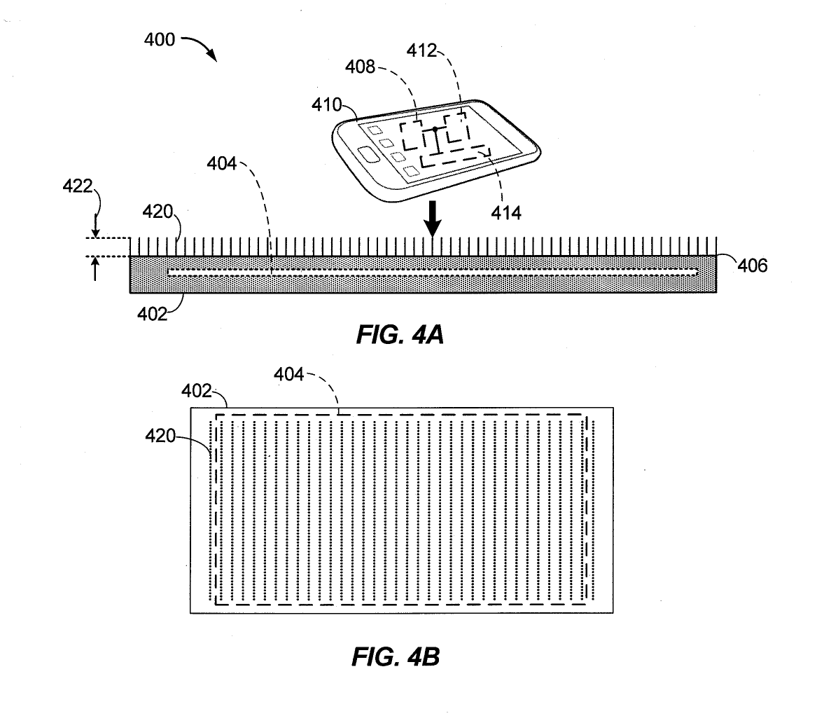

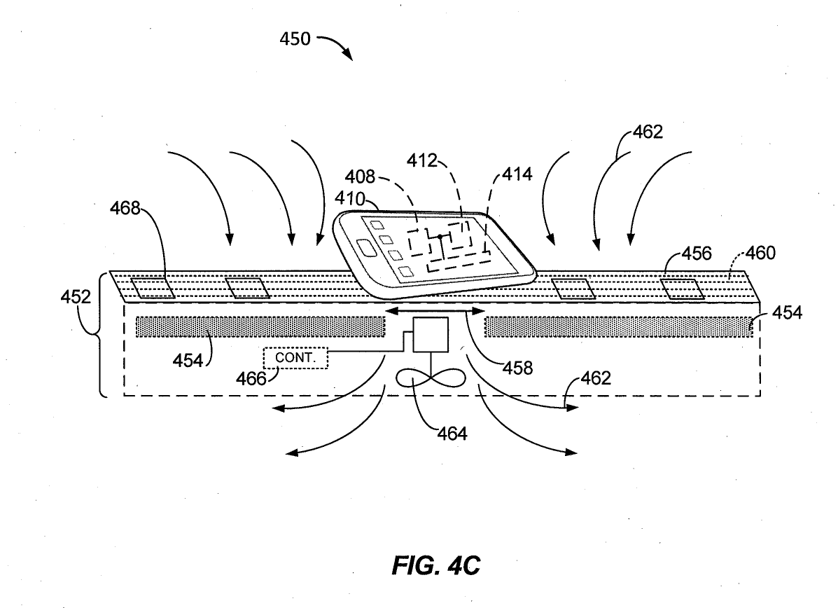

FIG. 4A is a side view of a thermal management system for wireless power transfer systems in accordance with an embodiment. As shown, a thermal management system (system) 400 comprises a charging pad 402. The charging pad 402 may also be referred to herein as the power transmitting unit (PTU) 402. The PTU 402 may comprise a transmitter 404, shown in dashed lines indicating its position internal to or beneath a charging surface 406 of the PTU 402. The transmitter 404 may be similar to the transmitter 104 (FIG. 1) and the power transmitter 204 (FIG. 2A, 2B) and be configured to generate a wireless field similar to the wireless field 105, 205. In some embodiments a coil/antenna of the PTU 402 may span a majority of the dimension of the PTU 402. As noted above, the wireless field (e.g., the wireless field 105, 205) may transmit wireless power to a wireless power receiving unit (PRU) 410. The wireless field is not shown in this figure for simplicity but should be understood as flowing from the PTU 402 to the PRU 410. As shown in FIG. 4A, the PRU 410 may be, for example a wireless mobile device. The PRU 410 may be similar to the PRU 260 (FIG. 2B), incorporating the various components described above.

In some embodiments, the PRU 410 may comprise a power receiver 408. The receiver 408 may be substantially similar to the receiver 108 (FIG. 1) and the power receiver 208 (FIG. 2A, 2B) and be configured to receive wireless power from the PTU 402. The receiver 408 may provide the wireless power directly to the PRU 410 or charge a power storage device 412, e.g., a battery. The PRU 410 may further comprise a processor 414 operably connected to the receiver 408, and configured to control the charging processes of the PRU 410. The processor 414 may be similar to the processor 262 (FIG. 2B). The PRU 410 may be, for example, a cellular phone, PDA, tablet computer, laptop, portable music player, or other portable device capable of receiving wireless power from the PTU 402. The PRU 410 may further be similar to the PRU 260 of FIG. 2B, comprising similar components and having similar characteristics.

The system 400 may produce waste heat while transmitting the wireless power from the PTU 402 to the PRU 410. In order to regulate or manage the waste heat produced by the system 400, the PTU 402 may be formed or otherwise fitted with geometrically optimized protrusions 420, pictured as lines disposed substantially orthogonal to the charging surface 406 of the PTU 402. Only one protrusion 420 is labeled for simplicity. It should be appreciated that the representation of the protrusions 420 in FIG. 4A is not drawn to scale.

The plurality of protrusions 420 may extend orthogonally from the charging surface 406 of the PTU 402 a distance, or length 422. In some embodiments, the plurality of protrusions 420 may extend at any other angle from the charging surface 406. The length 422 may be, for example, any length such that the protrusions 420 do not significantly impact or alter the magnetic field generated by the transmitter 404. In some embodiments, the wireless power transfer system 400 may be designed to incorporate the protrusions 420 such that the length of the protrusions 420 does not affect the magnetic field generated by the transmitter 404. In some embodiments, the length of the protrusions 420 may be based on their ability and effectiveness at convective heat transfer in relation to any impact on the magnetic field. The protrusions 420 may further be arranged having a horizontal separation between individual protrusions 420 of a value such that at least one of convective heat removal, the aesthetics, and surface grip are maximized. For example, the protrusions 420 may be 1000 microns in length and have 5000 microns separating each protrusion in one or more directions. Accordingly, the plurality of protrusions 420 may resemble small hairs or posts that, when the PRU 410 is placed upon them, provide a separation between the PRU 410 and the charging surface 406 of the PTU 402.

In an embodiment, the protrusions 420 may increase the physical separation between the PRU 410 and the charging surface 406 or the PTU 402 by the length 422 of the protrusions 420. The increased separation between the two components may allow air circulation and passive cooling of the PTU 402 and the PRU 410 by convection or similar means. Accordingly, the embodiment of this figure may be referred to generally as a passive cooling system. In other embodiments, the protrusions 420 may be arranged in any other pattern or two-dimensional layout.

FIG. 4B depicts a top view of the thermal management system of FIG. 4A, in accordance with an embodiment. As shown, the protrusions 420 may be arranged geometrically in rows and columns in order to evenly distribute the weight of the PRU 410 onto the protrusions 420 and to evenly distribute the convective effects about the protrusions 420.

FIG. 4C depicts a side view of a thermal management system, in accordance with another embodiment. As shown a thermal management system (system) 450 is shown, with the PRU 410 of FIG. 4A in contact with a PTU 452. The PTU 452 is similar to the PTU 402 and able to provide wireless power to the PRU 410. As shown, the PTU 452 is not drawn to scale, but encompasses the area bounded by the dashed lines. The PTU 452 may comprise a transmitter 454. The transmitter 454 is similar to the transmitter 404 and housed within the PTU 452 or beneath a charging surface 456, as noted by the dotted lines. The transmitter 454 of the system 450 is shown in two portions, depicting a central aperture 458. Accordingly, the system 450 as drawn in FIG. 4C may be viewed as a cross section of the PTU 452 having the central aperture 458. In another embodiment, the transmitter 454 may be formed in two portions or split into multiple smaller transmitters 454 providing separation between the portions of the transmitters 454.

The PTU 452 may be formed or otherwise constructed with a plurality of perforations 460. The perforations 460 may completely penetrate the PTU 452, providing a plurality of passages or paths through which air 462 can flow. The perforations may allow the air 462 to pass from one side of the PTU 452 to the other, increasing the convective heat transfer. For simplicity and figure clarity, the perforations 460 are only depicted in the charging surface 456 of the PTU 452. The air 462 is depicted as a series of arrows passing from the top of the PTU 452 through the perforations 460 in the charging surface 456 to the bottom of the PTU 452.

The PTU 452 of the system 450 may further comprise at least one fan 464 housed within the aperture 458. The fan 464 may be a low profile fan configured to increase the airflow through the perforations 460, thus increasing the convection and the cooling effects of the perforations 460 and the air 462. The at least one fan 464 may be controlled by a controller 466. The controller 466 may be similar to the processor 244 (FIG. 2B) and perform some or all of the processes described above in connection with the PTU 240.

The controller 466 may receive input from a plurality of sensors 468. The sensors 468 may be distributed about the charging surface 456 or embedded within the PTU 452. The sensors 468 are similar to the sensors 246 (FIG. 2B) and may be configured to sense a temperature of the charging surface 456 and a temperature of the PTU 452, in addition to sensing an ambient temperature surrounding the charging surface 456 and the PTU 452 as a whole. The controller 466 may activate the fan 464 in response to the input from the plurality of sensors 468 (e.g., ambient temperature and surface temperature), upon reaching a threshold temperature stored in the memory 244 or in accordance with certain communications or requests. For example, the PRU 410 may provide a command or request to activate the fan 464 in relation to a temperature of the PRU 410 or in accordance with the tuned thermal model 265 (FIG. 2B). Advantageously, the air 462 forced through the perforations 460 by the fan 464 increases convective cooling and may serve to manage waste heat of the system 450. This may actively increase convection and reduce the temperature of the PRU 410, increasing the C-rate of the charging process.

In certain embodiments, the protrusions 420 described in FIG. 4A and FIG. 4B may be combined with the perforations 460 of FIG. 4C. In other words, the system 450 may be further formed or constructed with the protrusions 420. In combination, the passive convective effects of the protrusions 420 and the active cooling effects of the perforations 460 and the fan 464 may further increase the amount of airflow possible around the device 410 and lead to further cooling effects, increasing the charging capacity of the PTU 402 and C-rate.

In some embodiments of the invention disclosed herein, a method for wirelessly transmitting power may comprise wirelessly transmitting power via a wireless power transmitter 404, 454 to a receiving device (for example, power receiving unit PRU 410) and cooling at least a portion of the wireless power transmitter 404, 454 via an array of protrusions 420. The array of protrusions 420 may be configured to cool at least a portion of a charging surface 406, 456 of the wireless power transmitter 404, 454. The array of protrusions 420 may be further configured to cover at least the portion of the charging surface 406, 456 in a two-dimensional layout and to extend away from the charging surface 406, 456. In some embodiments, as discussed above, the array of protrusions 420 may be disposed orthogonally on the charging surface 406, 456. In some embodiments, the method may further comprise cooling at least a portion of the charging surface 406, 456 of the wireless power transmitter 404, 454 via one or more perforations 460. The one or more perforations 460 may allow air 462 to flow through passages in the wireless power transmitter created by the one or more perforations 460, and the air 462 flowing through the wireless power transmitter may further cool the portion of the charging surface 406, 456 comprising the one or more perforations 460 in addition to or instead of the array of protrusions 420 disposed on the charging surface 406. In some embodiments, the method may further comprise generating air flow through the one or more perforations 460 or along the array of protrusions 420 using a fan 464 or other air flow generating means (for example, pressure change, passive air movers, etc.).

In some embodiments, the method for wirelessly transmitting power may include sensing at least a surface temperature of the charging surface or of at least the portion of the wireless power transmitter via one or more sensors (for example sensors 468). In some embodiments, the one or more sensors 468 may be disposed on or near the charging surface 406, 456 or within the wireless power transmitter 404, 454. In some embodiments, the generation of the air flow described above may be based on the sensed surface temperatures. For example, when the sensed temperature of the charging surface 406, 456 is above a threshold temperature, the method may generate the air flow to cool the charging surface 406, 456 using the air flowing through the one or more perforations 460 or over the array of protrusions 420. If the temperature of the charging surface 406, 456 is sensed to be below the threshold temperature, then the method may not generate the air flow and allow passive cooling to continue. In some embodiments, the method of wirelessly transmitting power may further include sensing an ambient temperature surrounding the charging surface 406, 456 and/or receiving communications from a power receiving unit (PRU 410) receiving the wirelessly transmitted power. The received communications may relate to a temperature of the power receiving unit PRU 410, and the generating of airflow through the one or more perforations 460 or over the array of protrusions 420 may be based, at least in part, on the received communications from the power receiving unit PRU 410.

Another aspect of the invention includes a method of forming a wireless power transmitting unit 402, 452. The method may comprise disposing an array of protrusions 420 orthogonally on a charging surface 406, 456 of the wireless power transmitting unit 402, 452. The method of forming the wireless power transmitting unit 402, 452 may further comprise extending the array of protrusions 420 may away from the charging surface 406, 456. The method of forming the wireless power transmitting unit 402, 452 may also comprise arranging the array of protrusions 420 in a two-dimensional layout on the charging surface 406, 456. In some embodiments, the method of forming the wireless power transmitting unit 402, 452 may include forming one or more perforations 460 configured to penetrate the charging surface 406, 456 and configured to create one or more passages through the wireless power transmitter 404, 454. In some embodiments, the method of forming the wireless power transmitting unit 402, 452 comprises positioning a fan 464 or other means for generating air flow such that air flows through the one or more perforations 460 or over the array of protrusions 420 to cool at least a portion of the charging surface 406, 456. In some embodiments, the method of forming the wireless power transmitting unit 402, 452 may also comprise placing a plurality of sensors 468 on the charging surface 406, 456 or within the wireless power transmitter 404, 454 such that the plurality of sensors 468 are configured to sense at least a surface temperature of the charging surface 406, 456. In some embodiments, the method of forming may also include using a controller 466 connected to the plurality of sensors 468 and the fan 464 or air flow generating means and configured to receive temperature information from the sensors 468 and selectively activate the fan 464 based on the surface temperature. In some embodiments, the method for forming the wireless power transmitting unit 402, 452 may also comprise configuring the plurality of sensors 468 to further sense an ambient temperature surrounding the charging surface 406, 456, and wherein the controller 466 is further configured to receive communications from a power receiving unit PRU 410. The communications received from the power receiving unit PUR 410 may be related to a temperature of the power receiving unit PUR 410, and the controller 466 may be further configured to selectively activate the fan 464 or air flow generating means based on the temperature of the power receiving unit PRU 410.

In some embodiments of the invention disclosed herein, a wireless power transmitting unit may comprise means for wirelessly transmitting power and means for receiving a chargeable device, the receiving means comprising an array of orthogonally disposed protrusions 420, the array of protrusions 420 arranged in a two-dimensional layout and configured to extend away from the receiving means. The wireless power transmitting means may comprise a wireless power transmitter or any other apparatus or device configured to wirelessly transmit power. The receiving means may comprise a charging surface 406, 456 or some surface upon which or near which a chargeable device may be placed and receive power wirelessly. In some embodiments, one or more of the wireless power transmitter 404, 454 and the charging surface 406, 456 may comprise an antenna and associated circuitry. In some embodiments, the wireless power transmitting unit 402, 452 may further comprise means for passing air through the receiving means, wherein the passing air means creates one or more passages through the wireless power transmitting unit. In some embodiments, the passing air means may comprise perforations 460 or slots that extend through the charging surface 406, 456 or at least a portion of the wireless power transmitter 404, 454. In some embodiments, the passing air means comprises any element of the wireless power transmitting unit 402, 452 that allows air to flow through or near the receiving means (charging surface 406, 456), wherein the air flow reduces the temperature of the receiving means. In some embodiments, the wireless power transmitting unit further comprises means for sensing at least a surface temperature of the receiving means (charging surface 406, 456) or of at least a portion of the wireless power transmitting means. The sensing means may be disposed on or near the receiving means or on or in the wireless power transmitting means. The air flow generating means may be configured to generate air flow based on the surface temperature sensed by the sensing means. In some embodiments, the sensing means may comprise one or more sensors 468 configured to detect temperature values. In some embodiments, the wireless power transmitting unit 402, 452 may further comprise means for sensing an ambient temperature surrounding the receiving means and means for receiving communications from a power receiving unit 410, the communications related to a temperature of the power receiving unit 410. In some embodiments, the ambient temperature sensing means may comprise one or more sensors 468 or similar devices configured to identify an ambient temperature.

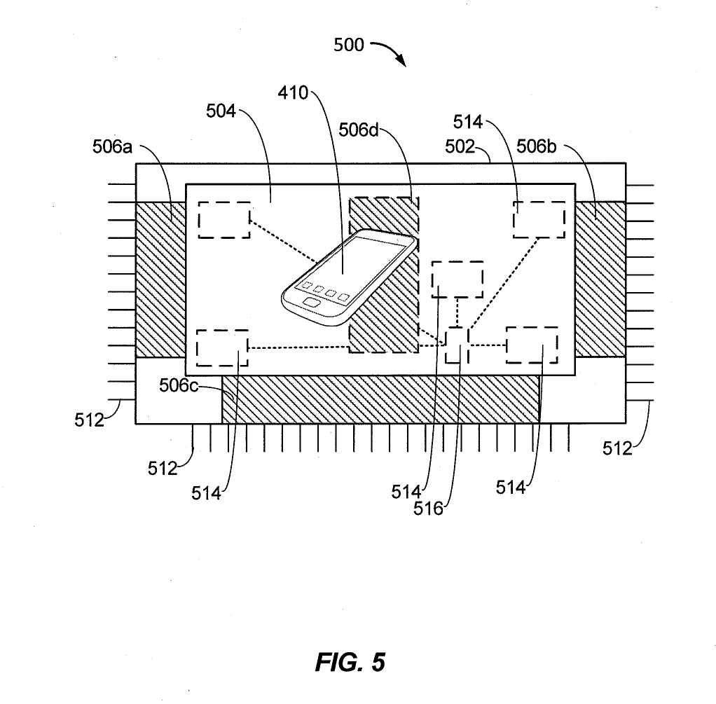

FIG. 5 depicts a top view of a PTU in accordance with another exemplary embodiment. As shown, a wireless charging system (system) 500 is shown. The system 500 comprises a PRU 410 in contact with a PTU 502, receiving wireless power, similar to the systems previously described. The PTU 502 may be similar to the PTU 240 (FIG. 2B) or the PTU 402 (FIG. 4A) and comprises a charging area 504 on the top surface of the PTU 502. The charging area 504 may comprise ceramic or composite materials. Such materials may offer improved thermal conductivity than most plastics and may further be magnetically compatible with the PTU 502/PRU 410 combination. Accordingly, such materials may be selected to have minimal interference with the wireless field emitted from the PTU 502.

The PTU 502 may further comprise one or more thermoelectric conductors (TEC) 506. As shown, four TECs 506a, 506b, 506c, 506d (referred to collectively as “TECs 506”) are shown operably connected to the PTU 502. The TECs 506 may be placed within and/or around the charging area 504. The TECs 506 may further be formed or otherwise connected to conductive portions of the charging area 504. As shown, the TECs 506a, 506b, 506c are disposed around the charging area 504. The TEC 506d is shown in dashed lines indicating that it is disposed upon or otherwise embedded within the charging area 504. The TECs 506 act as individual heat pumps, moving waste heat away from the PRU 410 and the charging area 504 toward a plurality of heat sinks 512. The heat sinks 512 may be formed about the periphery of the PTU 502 and be operably coupled to the TECs 506. The TECs 506 then operate to actively move waste heat from the PTU 502 surface toward the heat sinks 512 where the waste heat is dissipated through convection to the environment. The heat sinks 512 are shown on three sides of the PTU 502; however, they may be constructed, attached, or otherwise formed on any practical side of the PTU 502. The heat sinks 512 may further be formed of materials that do not interfere with the magnetic coupling of the PTU 502 with the PRU 410. Accordingly, the heat sinks 512 may comprise aluminum or other non-magnetic, heat conductive materials.

The ceramic construction of the PTU 502 in addition to the TECs 506 may have limited impact on magnetic coupling between the PTU 502 and the PRU 410 while providing an effective thermal path from the charging area 504 to the heat sinks 512. This serves to actively reduce the temperature of the charging area 504 and of the PRU 410. Additionally, the charging area 504 or the charging surface having better thermal conductivity due to the ceramic construction improves charging effectiveness.

The system 500 may further comprise a plurality of sensors 514. The sensors 514 may be similar to the sensors 246 (FIG. 2B) or the sensors 468 (FIG. 4C). The sensors 514 may be configured to sense a surface temperature of the charging area 504 or an ambient temperature surrounding the PTU 502. The sensors 514 may be operably connected to a processor 516 (shown in dashed lines). The processor 516 may be similar to the processor 242 and perform certain features of the PTU 502. In particular, each of the TECs 506 may also be operably connected to the processor 516. Accordingly, the TECs 506 may be selectively enabled and controlled based on thermal feedback from the sensors 514 or the sensor(s) 266 (FIG. 2B).

In another embodiment, the processor 516 may be further configured to receive temperature indications or communications from the PRU 410, indicating a need or request to activate the TECs 506. The PRU 410 may communicate with the PTU 502 (e.g., via the communication channel 219), providing temperature indications from the sensors 266 (FIG. 2B) or commands based on comparisons with the thermal models 265 (FIG. 2B). In some embodiments, the processor 516 may be configured to selectively enable and control the TECs 506 based on communications received from the PRU 410

In an embodiment, a single thin-film TEC 506 may further be incorporated into the system 500. In such an embodiment, the thin-film TEC 506 may cover a majority or all of the charging area 504 or the PTU 502 (not shown). The thin-film TEC 506 may further be operably coupled to the processor 516 and the sensors 514 in order to more effectively move waste heat away from the PRU 410 and the charging area 504.

In some embodiments, a fan (similar to the fan 464 of FIG. 4) may be included in the PTU 502 in proximity to the at least one heat sink 512 or one or more of the TECs 506 to help disperse the heat energy. For example, the fan (not shown in this figure) may be configured to force air through or across the at least one heat sink 512 or across the one or more TECs 506, which may result in increased dispersion of the heat in the at least one heat sink 512 or the one or more TECs 506. In such embodiments, the processor 516 may be configured to selectively enable the fan based on communications received from the PRU 410 or based on the surface temperature of the charging area 504 as sensed by one or more sensors of the plurality sensors 514.

Another aspect of the invention includes a method of wirelessly transmitting power. The method comprises sensing a surface temperature of a charging surface or charging area 504. The charging surface 504 may comprise one or more thermoelectric conductors 506, at least one heat sink 512 operably connected to the thermoelectric conductors 506, and one or more sensors 514. In some embodiments, the charging surface 504 may be part of a power transmitting unit 502 and the described method may be performed by the power transmitting unit 502. The method may further include receiving an indication of the sensed surface temperature of the charging surface 504. The sensed surface temperature may include the temperature where the power transmitting unit 502 is in contact or proximity with a power receiving unit 410. The method may also include selectively enabling the thermoelectric conductors 506 based at least in part on the sensed surface temperature. Activating the thermoelectric conductors 506 may allow the heat from the charging surface 504 to be transported to the one or more heat sinks 512 and dissipated away from the power transmitting unit 502. The method may further comprise sensing an ambient temperature surrounding the power transmitting unit 502 and receiving communications from the power receiving unit 410, the received communications related to a temperature of the power receiving unit 410, wherein the power receiving unit 410 is receiving the wirelessly transmitted power.

In some embodiments, the thermoelectric conductors 506 may comprise a thin film thermoelectric conductor configured to cover at least a portion of the charging surface 504. In some embodiments, the charging surface 504 comprises a ceramic material and the sensing of the surface temperature of the charging surface 504 is performed by the one or more sensors 514 disposed within or flush with the charging surface 504.

Another aspect of the invention includes a wireless power transmitting unit 502. The wireless power transmitting unit 502 comprises means for receiving a power receiving unit 410. In some embodiments, the receiving means may comprise a charging pad or charging surface or charging area 504 or some similar surface or device on or near which the power receiving unit 410 may be placed such that power is wirelessly transmitted from the power transmitting unit 502 to the power receiving unit 410. The receiving means comprises one or more means for conducting thermoelectric energy, one or more means for dispersing heat operably connected to the one or more thermoelectric energy conducting means and disposed on a peripheral edge of the receiving means, and one or more means for sensing a surface temperature of the receiving means. In some embodiments, the means for conducting thermoelectric energy may comprise any thermoelectric conductor 506 or similar device or apparatus or any device designed to conduct thermoelectric energy (for example, heat energy). The means for dispersing heat may comprise a heat sink 512 or a heat exchanger or any device configured to disperse heat from one device to another device or medium. The means for sensing a surface temperature of the receiving means may comprise a temperature sensor or similar device or sensor 514 configured to detect a temperature of a surface or an ambient temperature. The wireless power transmitting unit 502 further comprises means for receiving an indication of the sensed surface temperature and means for selectively enabling the one or more thermoelectric energy conducting means based at least in part on the surface temperature. The indication receiving means may comprise a controller or processor 516 or a similar component configured to receive and analyze information received, where the information may include data or indicative inputs. The means for selectively enabling the one or more thermoelectric energy conducting means may comprise a switch or similar mechanism configured to couple the heat dispersing means to the thermoelectric energy conducting means, such that heat from the charging surface 504 is transferred to the heat sink 512 via the thermoelectric conductors 506.

In some embodiments, the one or more sensing means of the wireless power transmitting unit are further configured to sense an ambient temperature surrounding the power transmitting unit and further comprising means for receiving communications from the power receiving unit 410. The received communications may relate, at least in part, to the temperature of the power receiving unit 410. In some embodiments, the one or more thermoelectric conducting means comprises a thin film thermoelectric conductor configured to cover at least a portion of the receiving means. In some embodiments, the receiving means comprises a ceramic material and wherein the one or more sensing means is disposed within or flush with the receiving means.

FIG. 6 depicts a thermal management system 600 according to another exemplary embodiment. The system 600 comprises a PTU 602. The PTU 602 may be similar to the PTU 402 (FIG. 4A), the PTU 452 (FIG. 4C), and the PTU 502 (FIG. 5).

The PTU 602 may comprise an active cooling system 604. The active cooling system 604 may be similar to the active cooling systems of the system 450 and the system 500. The active cooling system 604 may further comprise certain aspects of the passive cooling system 400. Accordingly, the active cooling system 604 may comprise the protrusions 420, the fan 464 (FIG. 4C) and the perforations 460 of the system 450, and the TECs 506 (FIG. 5).

The active cooling system 604 may be operably connected to a temperature controller (controller) 606. The controller 606 may be similar to the processor 242 (FIG. 2B) and may further comprise certain characteristics of the memory 242 and DSP 248 of the PTU 240. The controller 606 may be configured to receive inputs from one or more sensors 608. Three sensors 608a, 608b, 608c are shown but any number of sensors 608 may be employed. The sensors 608 may be configured to sense a temperature of the charging area (e.g., the charging area 504 of FIG. 5) of the PTU 602. Due to thermal power dissipation that occurs during wireless power transfer between the PTU 602 and a PRU 610, the active cooling system 604 may be employed to manage the temperature of the PTU 602 and the PRU 610 and prevent substantial power throttling or power cutoff caused by excessive heat during the power transfer.

The PRU 610 may be similar to the PRU 260 (FIG. 2B) and the PRU 410 (FIG. 4A, FIG. 4B, FIG. 4C). The PRU 610 may comprise a predictive thermal controller 612. The predictive thermal controller 612 may comprise certain aspects of the processor 262 (FIG. 2B) and the processor 466 (FIG. 4C). The predictive thermal controller 612 may receive input from various sensors, such as one or more temperature sensors 626. Three sensors 626a, 626b, 626c are shown and will be referred to collectively as temperature sensors 616. The sensors 626 may be distributed about the PRU 610 in positions that may be in contact with or close to the charging area (e.g. the charging area 504 of FIG. 5), similar to the sensors 514 of the PTU 502.

In an embodiment, the predictive thermal controller 612 may further receive a system power demand 620. The system power demand 620 may be a discrete input from the processor 262 or a combination of various inputs from, or states of, the UI 267, the DSP 268, the battery 412, the processor 414, and/or other inputs indicating an overall power demand of the system 600. Such an input may provide the predictive thermal controller 612 an advance indication of power requirements of the system 600 such that action may be taken to enable the active cooling system 604 and manage the temperature at the PTU 602/PRU 610 interface. In another embodiment, the PRU 610 may adjust power consumption to maintain an optimum thermal state. The power consumption adjustment may be output by the predictive thermal controller 612 but may remain internal to the PRU 610. The predictive thermal controller 612 may output a system power command 630 to convey a power consumption adjustment signal that may be used by the PRU 610 to maintain an optimum thermal state by controlling the power used by the wireless power transfer system.

The predictive thermal controller 612 may further comprise a tuned thermal model (thermal model) 614. The thermal model 614 may be similar to the thermal model 265 (FIG. 2B) and comprise a mathematical model describing the thermal power dissipation of the PRU 610 with reference to the charging state of the PRU 610. In some embodiments, the thermal model 614 may be capable of predicting a future temperature rise as a function of the system power demand 620. In some embodiments, the system power demand 620 may include both battery charging requirements as well as system power requirements. Not all of the power indicated in the system power demand 620 need be power used for charging or wireless power transfer. The thermal model 614 may also be used by the predictive thermal controller 612 to estimate temperature rise at predetermined locations at a future time using inputs from temperature sensors 626a, 626b, and 626c, and projected power dissipation, which may be calculated by the predictive thermal controller 612 based on the system power demand 620. In some embodiments, the tuned thermal model 614 may be matched to the target device (e.g., the device being charged, or the PRU 610). In some embodiments, the thermal model 614 may comprise a lookup table or a compilation or a plurality of reference values related to the temperature of the PRU 610. The temperatures of the PRU 610 may comprise temperatures during charging operations, system operations while charging (for example, use of the PRU 610 while it is being charged, e.g., video playback during charging) and various battery states. In some embodiments, the thermal model 614 may consider ambient temperature, input from the sensors 626a-626c indicating a PRU 610 temperature (e.g., the temperature at the charging surface), a charging state of the battery (e.g., the battery 412 of FIG. 4C)), the system power demand 620, and the system power command 630, among other inputs. The thermal model 614 may further incorporate maximum and minimum rates of change in PRU 610 temperature to provide temperature increase and decrease rate thresholds to which sensors 626a-626c information is compared. In some embodiments, the predictive thermal controller 612 may operate independently of controller 606 or may communicate certain information with the PTU 602. In some embodiments, the predictive thermal controller 612 may be programmed to control active temperature management (e.g., to send a command or to send a request to enable the active cooling system 604) based on the PRU 610 surface temperature, the PRU 610 thermal characteristics, and the PRU 610 commands or feedback.

The predictive thermal controller 612 may further generate the system power command (command) 630. The command 630 may be used internally by the PRU 610 to control power consumption/power demand of the PRU 610. In some embodiments, the system power command 630 may be a predictive command and may be used by the PRU 610 to control power consumption and demand before the temperature of the system 600 passes a maximum threshold. In some embodiments, the system power command 630 may be reactive and may be used by the PRU 610 to control power consumption and demand after the temperature of the system 600 passes the maximum threshold. In an embodiment, the thermal model 614 may predict that the PRU 610 will reach a threshold temperature. Accordingly, the predictive thermal controller 612 may generate other temperature related information 636 requesting the PTU 602 to enable the active cooling system 604 in response to the increased temperature or providing additional inputs and information to be used by the temperature controller 606 in controlling the active cooling system 604 or the PTU 602 in general. Conversely, as the temperature decreases, the opposite actions may be taken, whereby the system power command 630 may command the PTU 602 to deactivate the active cooling system 604 because it is not required. This may also serve to reduce power requirements of the PTU 602.

In certain embodiments, the various inputs enable the PRU 610, and more specifically the predictive thermal controller 612, to approximate or predict the steady state temperature rise at the PRU 610 for a given system and charging power demand of the PRU 610. Advantageously, the PRU 610 may then remain in an optimum temperature range for high C-rates. Thus, the PRU 610 may achieve a desired or optimum steady state power transfer (e.g., from the PTU 602) as constrained by the thermal environment without disruptive power throttling or power transfer cut-off in response to high PRU temperatures. The predictive or preemptive nature of the other cooling commands 636 may prevent large swings in temperature through selective implementation of the active cooling system 604.

The PRU 610 may further be capable of communicating a PRU device temperature 632 and a PRU target device temperature 634 to the PTU 602. Such communication may be transmitted via the communication channel 219. The PTU 602 and more specifically the temperature controller 606 may utilize the PRU device temperature 632 and the PRU target device temperature 634 as indicators to activate or deactivate the active cooling system 604.

In an embodiment, the PTU 602 may receive the PRU device temperature 632 that is higher than the PRU target device temperature 634 and activate the active cooling system 604 in response to the difference in temperature. In another embodiment, the PTU 602 may compare the device temperature 632 to a stored threshold temperature (e.g., in the memory 244 of FIG. 2B), activating the active cooling system 604 if the temperature is above the stored threshold.

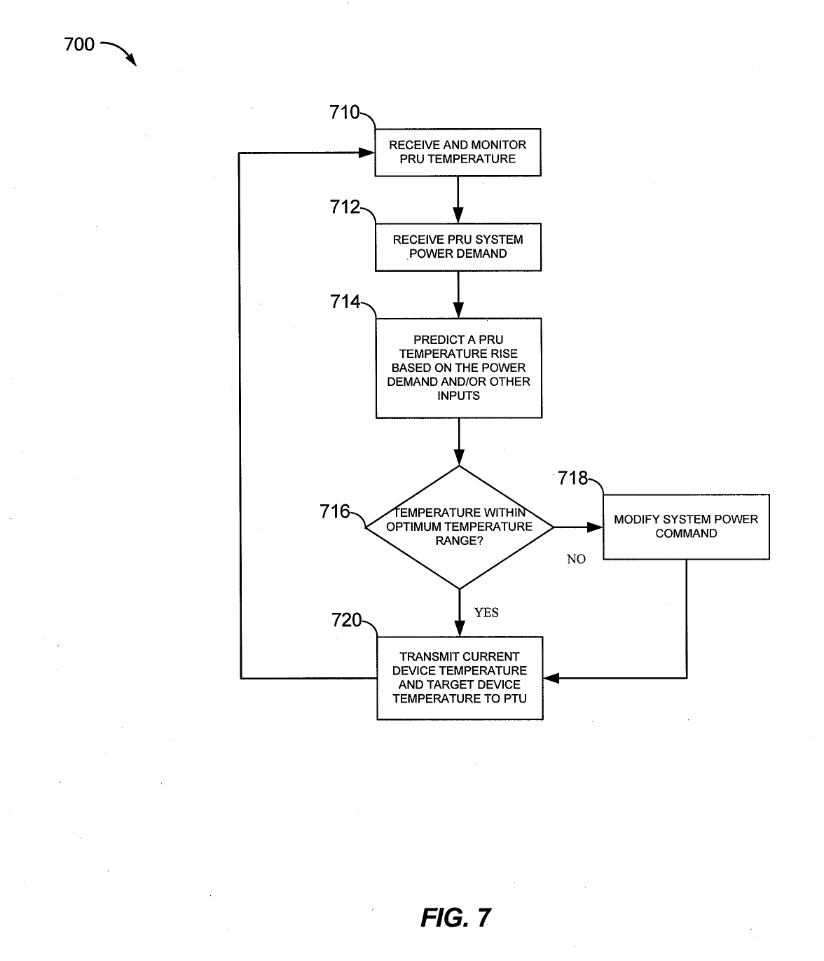

FIG. 7 is a flowchart depicting a method for managing thermal power dissipation according to the disclosure. As shown, a method 700 begins at block 710 when the PRU 610 (FIG. 6) receives input from the sensors 626 regarding the temperature of the PRU 610, an ambient temperature, or other pertinent values. The inputs from the sensors 626a-626c may be used to monitor the PRU 610 temperature by the predictive thermal controller 612. The sensors 626 may provide a variety of information including the temperature of the PRU 610, a temperature of the charging surface (e.g., the charging surface 456), the ambient temperature of the environment surrounding the PTU 602 and the PRU 610, and a rate of change of the temperatures, among other data.

At block 712, the PRU 610 may receive the PRU system power demand 620. As discussed above, the system power demand 620 may be used by the predictive thermal controller 612 to monitor the temperature of the PRU 610 and to calculate temperature thresholds. In some embodiments, the predictive thermal controller 612 may use the tuned thermal model 614 in calculating the temperature thresholds. In some embodiments, the predictive thermal controller 612 may use the inputs received at block 710 with the system power demand 620 to calculate thresholds. Additionally, as shown at block 714, the predictive thermal controller 612 may use the system power demand 620 and the inputs received at block 710 to calculate or predict a PRU 610 temperature rise. In some embodiments, the predictive thermal controller 612 may use only the system power demand 620 and the tuned thermal model 614 to predict PRU 610 temperature rises. In some embodiments, the predictive thermal controller 612 may predict a future, steady-state temperature.

At block 716, the predictive thermal controller 612 may compare the received and monitored PRU 610 temperature from block 710 with the tuned thermal model 614 and may analyze the monitored PRU 610 temperature in view of the system power demand 620. Additionally, the predictive thermal controller 612 may analyze the temperature data provided by the sensors 626 and the rate of change of the temperature data (as may be determined by block 714). If the predictive thermal controller 612 determines the temperature indications are within an optimum temperature range or below a temperature threshold according to the tuned thermal model 614, then no change may be required. The method 700 may then proceed to block 720. If the predictive thermal controller 612 determines that the measured PRU 610 temperature is not within the optimum temperature range or is not below the temperature threshold, the method 700 may proceed to block 718, where the predictive thermal controller 612 may transmit the system power command 630 to the PRU 610. The system power command 630 may instruct the PRU 610 to reduce its power consumption or charging requirements due to the current temperature of the PRU 610 exceeding the optimum temperature. Then, after the system power command 630 is transmitted to the PRU 610, the method 700 proceeds to block 720.

At block 720, the predictive thermal controller 612 may transmit the PRU 610 measured/monitored temperature and target temperature to the PTU 602. In some embodiments, the predictive thermal controller 612 may send requests to the PTU 602 (for example, a request to enable the active cooling system 604) based on the determination at block 716 whether the temperature is within the optimum range. After transmitting the PRU 610 temperature to the PTU 602, the method 700 repeats beginning at block 710.

As such, in accordance with some embodiments, a PTU 602 configured for wirelessly charging a PRU 610 may receive information indicative of a temperature of the PRU 610. The PTU 602 may be configured to adjust one or more parameters of a temperature cooling system 604 at the PTU 602 to reduce a temperature of a PRU 610 as it is being charged or is placed on the charging pad. As described above, the larger physical dimensions may include one or more properties that efficiently allow it to be desired and/or include components to at least partially manage a temperature of the PRU 610.

Another aspect of the invention includes a method for wirelessly receiving power. The method comprises providing an indication of a surface temperature of a power receiving unit 610 at a position in contact with a power transmitting unit 602. The method further comprises storing a tuned thermal model 614 of the power receiving unit 610. The method also includes predicting a temperature rise at the power receiving unit based at least in part on the provided indication of the surface temperature of the power receiving unit 610 and a power demand 620 of the power receiving unit 610. The method also comprises generating a transmission 632, 634, 636 to the power transmitting unit 602 based at least in part on the surface temperature and a target temperature from the tuned thermal model 614 and transmitting the generated transmission to the power transmitting unit 602.

In some embodiments, the method may further comprise sensing an ambient temperature surrounding the power receiving unit 610 and wherein the transmission 632, 634, 636 is further generated based at least in part on the ambient temperature surrounding the power receiving unit 610. In some embodiments, the tuned thermal model 614 comprises a plurality of reference values related to thermal power dissipation during wireless charging operations. For example, the reference values may be based on at least one of a battery charge state, or a power receiving unit temperature, or an ambient temperature, or a received transmit power level from the power transmitting unit 602, or any combination thereof. In some embodiments, the reference values are further based on a rate of increase or a rate of decrease in the surface temperature of the power receiving unit 610.

In some embodiments, the temperature rise predicting is based at least in part on the power demand 620 of the power receiving unit 610, wherein the power demand 620 is an indication of the amount of power required by the power receiving unit 610. In some embodiments, the method further comprises requesting the power transmitting unit 602 to enable an active cooling system 604.

Another aspect of the invention includes a wireless power receiving unit 610. The wireless power receiving unit comprises means for providing an indication of a surface temperature of a power receiving unit 610 at a position in contact with a power transmitting unit 602. In some embodiments, the means for providing an indication of a surface temperature may comprise a temperature sensor 626 or some similar device or sensor configured to detect a temperature of a surface in contact with the sensor 626 or in the vicinity or line of sight of the sensor 626. The wireless power receiving unit 610 further comprises means for storing a tuned thermal model 614 of the power receiving unit 610. The means for storing the tuned thermal model 620 may comprise a memory or similar database structure configured to store information for later use. The wireless power receiving unit 610 also includes means for predicting a temperature rise at the power receiving unit 610 based at least in part on the provided indication of the surface temperature of the power receiving unit 610 and a power demand 620 of the power receiving unit 610. The predicting means may comprise a controller or processor 612 or similar component or device configured to receive one or more inputs and make a prediction of a temperature rise of the power receiving unit 610 based on the received inputs, wherein the received inputs may include information stored in memory. The wireless power receiving unit 610 also comprises means for generating a transmission to the power transmitting unit 602 based at least in part on the indicated surface temperature and a target temperature from the tuned thermal model 614 and means for transmitting the generated transmission to the power transmitting unit 602. The means for generating a transmission may comprise the controller 612 described or a transmission circuit dedicated to generating transmissions. The means for transmitting may comprise a transmit circuit or a transmit antenna or similar components or structures configured to enable transmission or communication of generated messages and transmission.

In some embodiments, the power receiving unit 610 further comprises means for sensing an ambient temperature surrounding the power receiving unit 610 and wherein the transmission generation means is further configured to generate the transmission based at least in part on the ambient temperature surrounding the power receiving unit 610. In some embodiments, the tuned thermal model 614 comprises a plurality of reference values related to thermal power dissipation during wireless charging operations, the reference values based on at least one of a battery charge state, or a power receiving unit temperature, or an ambient temperature, or a received transmit power level from the power transmitting unit 602, or any combination thereof. In some embodiments, the reference values are further based on a rate of increase or a rate of decrease in the surface temperature of the power receiving unit 610.

In some embodiments, the predicting means further comprises predicting the temperature rise based at least in part on the power demand 620 of the power receiving unit 610, wherein the power demand 620 is an indication of the amount of power required by the power receiving unit 610 or further comprises means for requesting the power transmitting unit 602 enable an active cooling system 604.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC. For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless power transmitting unit, comprising:
a wireless power transmitter; and
a charging surface at least partially covering the wireless power transmitter, the charging surface formed with an array of orthogonally disposed protrusions, the protrusions configured to extend away from the charging surface.

2. The wireless power transmitting unit of claim 1, further comprising a plurality of perforations, the plurality of perforations configured to penetrate the charging surface.

3. The wireless power transmitting unit of claim 2, further comprising a fan disposed beneath the charging surface, the fan configured to force air through the plurality of perforations.

4. The wireless power transmitting unit of claim 3, further comprising:
a plurality of sensors disposed on the charging surface, the plurality of sensors configured to sense at least a surface temperature of the charging surface and generate temperature indications of the surface temperature; and
a controller configured to receive the temperature indications from the sensors and selectively activate the fan based at least in part on the sensed surface temperature.

5. The wireless power transmitting unit of claim 4, wherein the plurality of sensors are further configured to sense an ambient temperature surrounding the charging surface, and wherein the controller is further configured to receive communications from a wireless power receiving unit, the communications related to a temperature of the wireless power receiving unit.

6. The wireless power transmitting unit of claim 5, wherein the controller is further configured to selectively activate the fan based at least in part on the communications received from the wireless power receiving unit related to the temperature of the wireless power receiving unit.

7. A wireless power transmitting unit, comprising:
a charging surface configured for placement of one or more devices to be wirelessly charged via the wireless power transmitting unit, the charging surface comprising:
one or more thermoelectric conductors;
at least one heat sink operably connected to the one or more thermoelectric conductors and disposed on a peripheral edge of the charging surface; and
one or more sensors configured to sense a surface temperature of the charging surface; and
a controller operably connected to the one or more thermoelectric conductors and the one or more sensors, the controller being configured to receive an indication of the surface temperature and selectively enable the one or more thermoelectric conductors based on the surface temperature.

8. The wireless power transmitting unit of claim 7, wherein the one or more sensors are configured to sense an ambient temperature surrounding the power transmitting unit, and wherein the controller is configured to further receive communications from a wireless power receiving unit, the communications related to a temperature of the wireless power receiving unit.

9. The wireless power transmitting unit of claim 8, wherein the controller is further configured to selectively enable the one or more thermoelectric conductors based on the communications received from the wireless power receiving unit.

10. The wireless power transmitting unit of claim 9, wherein the controller is further configured to selectively enable a fan based on the communications received from the wireless power receiving unit, the fan disposed in proximity to the at least one heat sink and configured to force air across the at least one heat sink

11. The wireless power transmitting unit of claim 7, wherein the one or more thermoelectric conductors each comprises a thin film thermoelectric conductor configured to cover at least a portion of the charging surface.

12. The wireless power transmitting unit of claim 7, wherein the charging surface comprises a ceramic material, and wherein the one or more sensors are disposed within or flush with the charging surface.

13. The wireless power transmitting unit of claim 7, further comprising a fan disposed in proximity to the at least one heat sink, the fan configured to force air across the at least one heat sink.

14. The wireless power transmitting unit of claim 13, wherein the controller is further configured to selectively enable the fan in response to the surface temperature exceeding a threshold temperature.

15. A power receiving unit for wirelessly receiving power, comprising:
at least one sensor configured to provide an indication of a surface temperature of the power receiving unit at a position in contact with a power transmitting unit from which the power receiving unit wirelessly receives power;
a memory configured to store a tuned thermal model of the power receiving unit;
a predictive thermal controller operably coupled to the at least one sensor and the memory and configured to:
predict a temperature rise at the power receiving unit based at least in part on the indication provided by the at least one sensor and a power demand of the power receiving unit; and
generate a transmission to the power transmitting unit based on the surface temperature and a target temperature from the tuned thermal model; and
a transceiver configured to transmit the transmission to the power transmitting unit.

16. The power receiving unit of claim 15, wherein the at least one sensor is further configured to sense an ambient temperature surrounding the power receiving unit, and wherein at least one of the predicted temperature rise and the generated transmission to the power transmitting unit is further based on the ambient temperature.

17. The power receiving unit of claim 15, wherein the tuned thermal model comprises a plurality of reference values related to thermal power dissipation during wireless charging operations, the reference values based on at least one of a battery charge state, or a power receiving unit temperature, or an ambient temperature, or a received transmit power level from the power transmitting unit, or any combination thereof.

18. The power receiving unit of claim 17, wherein the reference values are further based on a rate of increase or a rate of decrease in the power receiving unit temperature.

19. The power receiving unit of claim 15, wherein the predictive thermal controller is further configured to compare the power demand of the power receiving unit, wherein the power demand is an indication of the amount of power required by the power receiving unit.

20. The power receiving unit of claim 15, wherein the transceiver is further configured to transmit a signal to the power transmitting unit requesting the power transmitting unit enables an active cooling system.
